(19) United States
(12) Patent Application Publication
(10) Pub. No.: US 2026/0124638 A1
(43) Pub. Date: May 7, 2026

(54) STOWAGE CRADLE SYSTEM FOR DISPENSING GUN STOWAGE OF A CARTRIDGE CLOSURE AND DISPENSING GUN THEREWITH

(71) Applicant: PATENT & INVESTMENT LLC, HANOVER, MD (US)

(72) Inventors: ALBERT LEE, CLARKSVILLE, MD (US); BRIAN GLASS, WEST FRIENDSHIP, MD (US); TYLER HIPPEN, CROFTON, MD (US)

(21) Appl. No.: 18/934,675

(22) Filed: Nov. 1, 2024

(51) Int. Cl. B05C 17/005; B65D 51/00

(52) U.S. Cl. CPC B05C 17/0052; B65D 51/00

(57) ABSTRACT

A stowage cradle system incorporated into a dispensing gun for extruding a work material from a cartridge is provided for stowage of a work material cartridge closure therein. The stowage cradle system includes at least one engagement member disposed in an interior space of one of the handle or the trigger of the dispensing gun to define a stowage space for the work material cartridge closure. The engagement member has a pair of laterally spaced arms extending longitudinally from an arcuate wall disposed therebetween. A retention opening is defined between the pair of arms and the arcuate wall. End portions of each of the arms have a projecting portion extending into the retention opening to reduce the opening dimension therebetween. By that arrangement, the work material cartridge closure is releasably frictionally retained within the retention opening by the projecting portions of the pair of arms of the engagement member.

### BACKGROUND OF THE INVENTION

The present invention is broadly directed to dispensing gun stowage of accessories used therewith. More specifically, the present invention is directed to a cradle system to provide onboard stowage of a cartridge closure, which has particular utility for use in resealing a cartridge of a partially consumed extrudable work material. The stowage cradle system provides convenience and preserves the viability of work material between applications thereof, and prevents loss of the work material due to dripping. The disclosed stowage cradle system is nonobtrusive to the operation of the dispensing gun into which it is installed and yet provides a readily available closure for a partially used cartridge of extrudable work material.

Various dispensing guns for dispensing sealants, adhesive, epoxy, caulk, and other such viscous work materials are known in the art. They include handheld gun-type devices in which a cartridge containing a work material is loaded for engagement by the device's drive mechanism. Such drive mechanisms, when actuated, force the extrusive flow of the viscous work material out from the loaded cartridge and onto a particular work surface or area. Often, there comes a time when the application of work material has stopped, yet not all of the work material has been dispensed from the cartridge. To prevent the curing of drying out of the work material during periods of nonuse, many different types of cartridge closures have been devised. Although these devices function to reseal work material cartridges, they are inconvenient to users, as they must be carried on the person of the user or be stored in relatively close proximity to the area where the application of the work material is being carried out. To overcome this inconvenience, cartridge closures and containers for such closures have been devised to attach to dispensing guns. However, such attachable containers and cartridge closures have not been unobtrusive to the users and are thus inconvenient to use.

Accordingly, there is a need for a cartridge closure stowage system that is unobtrusively incorporated into a dispensing gun type device. Such a system provides convenient availability of a cartridge closure when needed, but without such a stowage system interfering with the use of the dispensing gun to apply an extrudable work material to a work surface.

### SUMMARY OF THE INVENTION

A stowage cradle system incorporated into a dispensing gun for stowage of a work material cartridge closure is provided. The dispensing gun has a frame body configured for extruding a work material from a cartridge, a handle extending from the frame body and a trigger being angularly displaceable with respect to the handle. The cradle system includes at least one engagement member disposed in an interior space of one of the handle or the trigger to define a stowage space for the work material cartridge closure. The engagement member has a pair of laterally spaced arms extending longitudinally from an arcuate wall disposed therebetween. The engagement member has a retention opening defined between the pair of arms and the arcuate wall. End portions of each of the arms have a projecting portion extending into the retention opening to reduce an opening dimension therebetween. As a result of that arrangement, the work material cartridge closure is releasably frictionally retained within the retention opening by the projecting portions of the pair of arms of the engagement member.

From another aspect, a dispensing gun having work material cartridge closure onboard stowage system is disclosed. The dispensing gun includes a frame body including a handle housing and a cartridge frame portion extending from the handle housing and adapted for receiving a cartridge of a work material therein. The dispensing gun further includes a handle extending from the handle housing, and a drive mechanism operably coupled to the frame body. The drive mechanism includes a drive member passing displaceably into the cartridge frame portion for forcing extrusion of work material from a cartridge of work material selectively positioned in the cartridge frame portion. Further, the dispensing gun includes a trigger pivotally coupled to the frame body for angular displacement of the trigger relative to the handle. The trigger is operatively coupled to the drive mechanism for displacing the drive member responsive to the angular displacement of the trigger. Still further, the dispensing gun includes a stowage cradle system disposed in an interior space of one of the handle or the trigger to define a stowage space into which a work material cartridge closure is releasably retained. The stowage cradle system includes at least one engagement member configured to releasably frictionally retain the work material cartridge closure within a retention opening formed in the at least one engagement member.

### BRIEF DESCRIPTION OF THE DRAWINGS

FIG. 1A is an elevation view of a work material cartridge closure usable with the present invention;

FIG. 1B is a left end elevation view of the work material cartridge closure of FIG. 1A,

FIG. 2 is a bottom rear perspective view of a dispensing gun formed with an exemplary stowage cradle system of the present invention showing a work material cartridge closure retained therein;

FIG. 3 is a rear, side perspective view of the dispensing gun of FIG. 2;

FIG. 4 is an elevation view of a section of the trigger of the dispensing gun of FIG. 2 showing an exemplary configuration of the stowage cradle system of the present invention;

FIG. 5 is a rear perspective view of a section of the trigger of the dispensing gun of FIG. 2 showing the exemplary stowage cradle system of FIG. 4;

FIG. 6 is a rear perspective view of the exemplary stowage cradle system of FIG. 4 showing a work material cartridge closure retained therein;

FIG. 7 is a perspective view of a second engagement member of the exemplary stowage cradle system of FIG. 4;

FIG. 8 is a perspective view of a first engagement member of the exemplary stowage cradle system of FIG. 4;

FIG. 9 is a perspective view of a support member of the exemplary stowage cradle system of FIG. 4;

FIG. 10 is a bottom rear perspective view of a dispensing gun formed with another exemplary stowage cradle system of the present invention showing a work material cartridge closure retained therein;

FIG. 11 is a bottom rear perspective view of the dispensing gun and exemplary stowage cradle system of FIG. 10;

FIG. 12 is an elevation view of a section of the trigger of the dispensing gun of FIG. 10 showing the exemplary stowage cradle system of FIG. 11;

FIG. 13 is a cross-sectional view of the exemplary stowage cradle system of FIG. 11;

FIG. 14 is a perspective view of the engagement member of the exemplary stowage cradle system of FIG. 11 sectioned from the trigger;

FIG. 15 is a bottom rear perspective view of a dispensing gun formed with yet another exemplary stowage cradle system of the present invention showing a work material cartridge closure retained therein;

FIG. 16 is a bottom rear perspective view of the dispensing gun and exemplary stowage cradle system of FIG. 15;

FIG. 17 is a cross-sectional view of the exemplary stowage cradle system of FIG. 11;

FIG. 18 is a rear perspective view of the support member of the exemplary stowage cradle system of FIG. 16;

FIG. 19 is a front perspective view of the support member of the exemplary stowage cradle system of FIG. 16;

FIG. 20 is a top perspective view of the engagement member of the exemplary stowage cradle system of FIG. 16 sectioned from the trigger;

FIG. 21 is a bottom perspective view of the engagement member of the exemplary stowage cradle system of FIG. 16 sectioned from the trigger;

FIG. 22 is a top front perspective view of a dispensing gun formed with a further exemplary stowage cradle system of the present invention showing a work material cartridge closure retained therein;

FIG. 23 is a bottom rear perspective view of the dispensing gun of FIG. 22 showing a recess formed in the trigger thereof;

FIG. 24 is a bottom front perspective view of the dispensing gun and exemplary stowage cradle system of FIG. 22;

FIG. 25 is a top front perspective view of the dispensing gun and exemplary stowage cradle system of FIG. 22;

FIG. 26 is a canted perspective view of a section of the dispensing gun handle and exemplary stowage cradle system therein; and

FIG. 27 is a is an uncanted perspective view of the section of the dispensing gun handle and exemplary stowage cradle system shown in FIG. 26.

### DETAILED DESCRIPTION OF THE PREFERRED EMBODIMENTS

The use of dispensing guns for extruding work materials, such as caulk and adhesives, from cartridges has been carried out by craftsmen and do-it-yourselfers for decades. With such usage, it quickly became apparent that some means for closing a cartridge that was only partially consumed was needed. As necessity is said to be the mother of invention, a variety of cartridge closures were made available and achieved acceptance in the market place. Generally, there have been two types of cartridge closures, caps, which fit over the distal end of the cartridge's nozzle, and plugs, which are inserted into the cartridge's nozzle opening. The one issue that both types of cartridge closures have in common is that the user must separately transport a cartridge closure and retrieve it when needed.

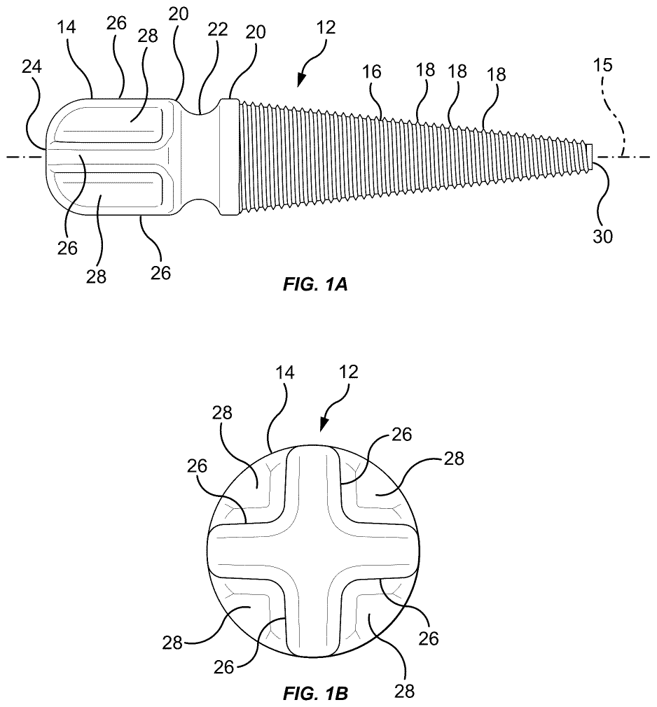

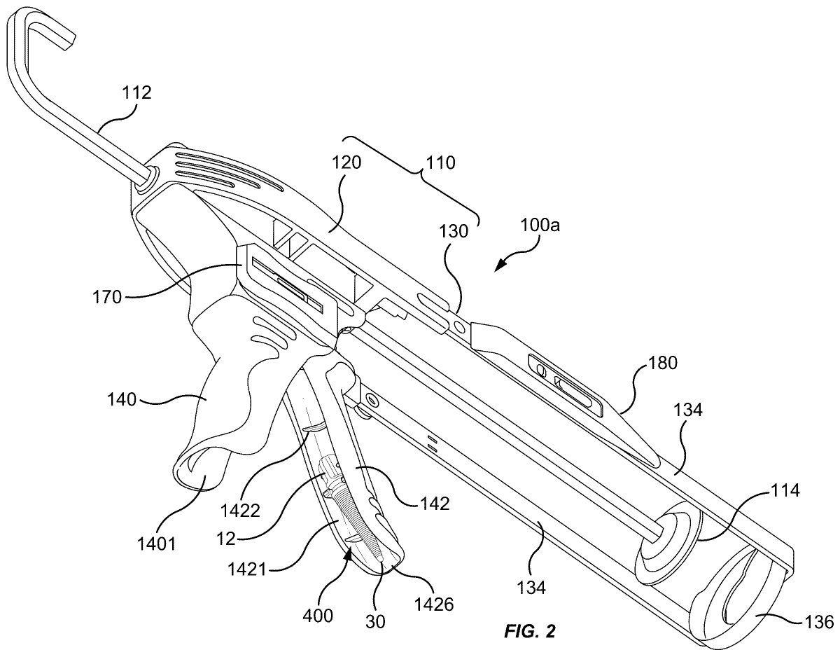

While stowage systems for scraping and finishing tools, that are frequently used when a work material is extruded from a cartridge to a work surface, have been incorporated into dispensing guns for the user's convenience, cartridge closures have heretofore not been unobtrusively stowed on a dispensing gun. To overcome this deficiency, a cartridge closure plug 12, as shown in FIGS. 1A and 1B, has been developed in concert with a stowage cradle system that releasably retains the cartridge closure plug 12 in one of the handle or the trigger of a dispensing gun.

Referring to FIG. 1A, the cartridge closure plug 12 includes a conically tapered lower portion 16 terminating at a distal end 30 and on which are formed helical scoring edges 18. When the lower portion 16 is inserted into a nozzle opening and then screwed into it, the scoring edges 18 form grooves on the interior of the nozzle and meshing of the scoring edges 18 with the groves as the nozzle tip is expanded by the conical tapper of the lower portion 16, in combination with residual work material remaining in the nozzle, creates an air-tight seal. The lubricity of the plastic material from which the cartridge closure plug 12 is formed and its resistance to adhesive bonding allows for unscrewing of the cartridge closure plug 12 from the nozzle for continued use of the cartridge.

The cartridge closure plug 12 has a head portion 14 at the proximal end 24. The head portion 14 is formed with wings 26 extending laterally about the longitudinal axis 15. Each adjacent pair of wings 26 are separated by angular recesses or gaps 28 that make grasping of the wings 26 easier, and thereby allow a user to manually rotate the cartridge closure plug 12 to engage the lower portion 16 into a nozzle opening. The cartridge closure plug 12 is further formed with a circumferential groove 22 bounded at each of the head portion 14 and lower portion 16 by respective ridges 20, 20. The combination of the groove 22 and ridges 20, 20 provide the primary structures of the cartridge closure plug 12 that are utilized by the cartridge closure cradle system for retention of the cartridge closure plug 12 on a dispensing gun disclosed in following paragraphs.

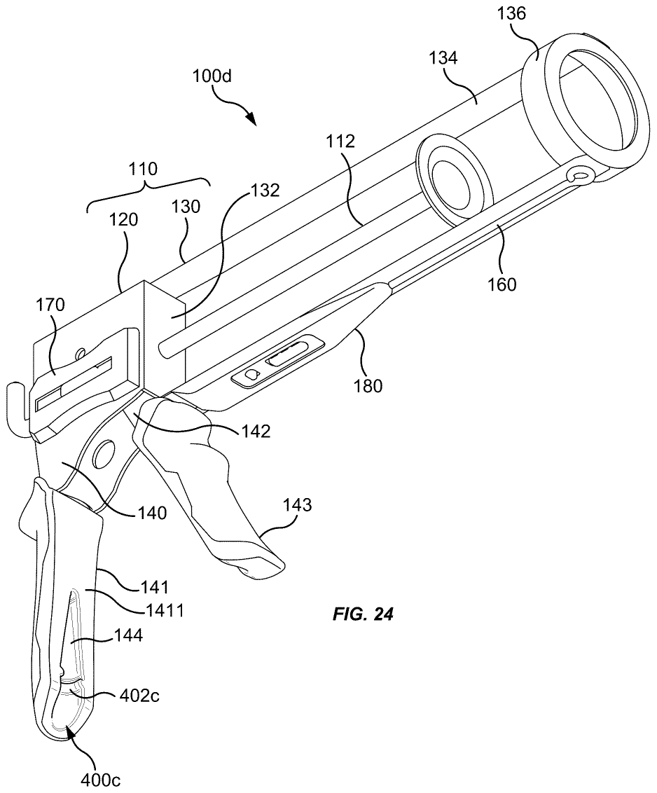

Referring now to FIGS. 2, 3, 10, 11, 15, 16 and 22-25, there is illustratively shown a dispensing gun 100a, 100b, 100c, 100d equipped with a corresponding onboard cartridge closure stowage cradle system 400, 400a, 400b, 400c. Each dispensing gun 100a, 100b, 100c, 100d includes a frame body 110 that may accommodate stowage of accessory tools, such as the hand tools 170 and 180 that are releasably coupled to the frame body 110 until such time that a user chooses to make use of the accessory tool 170, 180, and at which time the accessory tool 170, 180 is easily separated from the dispensing gun 100a, 100b, 100c, 100d for such use. Similarly, the cartridge closure stowage cradle system 400, 400a, 400b, 400c retains a cartridge closure plug 12 until such time that a user removes the cartridge closure plug 12 from the cartridge closure stowage cradle system 400.

The inventive concepts disclosed herein are directed to stowage of a cartridge closure plug 12, and stowage refers to the process of arranging and securing a cartridge closure plug 12 on one of a handle or trigger of a dispensing gun 100a, 100b, 100c, 100d. Stowage of the cartridge closure plug 12 involves optimizing the use of space and ensuring that the cartridge closure plug 12 is unobtrusively secured during transport and use of the dispensing gun 100a, 100b, 100c, 100d. To accommodate the releasable retention of cartridge closure plug 12, the cartridge closure stowage cradle system 400, 400a, 400b and 400c provides at least one engagement member 402, 402a, 402b, 402c that is disposed in one of the handle 140 or trigger 142.

Generally, the dispensing gun 100a, 100b, 100c, 100d has a frame body 110 which is formed by a handle housing 120 and a cartridge frame 130 that is coupled to the handle housing 120 and extends longitudinally therefrom. The cartridge frame 130 is suitably constructed to maintain stable support and secure retention of a work material cartridge loaded therein when the dispensing gun is operated. The handle housing 120 includes a handle 140 which extends therefrom, as shown in the appended drawings. The handle housing 120 also includes a trigger 142 pivotally coupled to an upper part of the handle member 140 in some dispensing gun configurations, or pivotally coupled to the handle housing 120 in other dispensing gun configurations, for pivotal displacement thereabout relative to the handle 140. Neither arrangement of pivotal coupling of the trigger is important to the inventive concepts being disclosed herein, and are well known in the art.

The handle housing 120 also serves as the housing for the hardware that implements the drive mechanism of the dispensing gun. The mechanical assembly of elements that form the drive mechanism and their coupling to both the trigger 142 and drive member 112 are likewise not important to the inventive concepts being disclosed herein and also very well known in the art. The handle housing 120 is formed to define one or more compartments to house any suitable type and combination of drive mechanism elements known in the art that may be utilized for a given dispensing gun 100a, 100b, 100c, 100d. Such drive mechanism hardware housed by the handle housing 120 (not shown) may include, for example, a ratcheting or other suitable mechanism known in the art for retractably advancing a plunger disc 114, that is coupled to a distal end of the drive member 112, into the cartridge loading compartment defined by the cartridge frame 130.

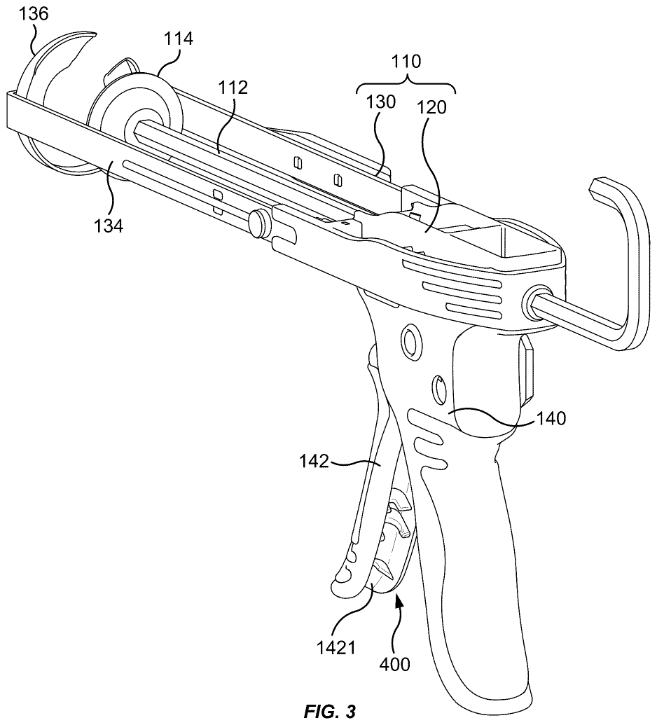

Referring now specifically to FIGS. 2 and 3, the dispensing gun 100a is shown having a cartridge closure stowage cradle system 400 disposed in a stowage space 1421 of the trigger 142. Dispensing gun 100a includes a frame body 110 which is formed by a handle housing 120 and a cartridge frame 130 coupled to the handle housing 120 and extends longitudinally therefrom. The handle housing 120 includes a handle member 140 extending in a transverse direction with respect to the longitudinal direction, as is conventional. The handle housing also includes a trigger member 142 that is pivotally connected to the handle member 140 and operatively coupled to a conventional drive mechanism (not shown) of the dispensing gun 100a. Responsive to displacement of the trigger member 142 toward the handle member 140, the drive mechanism 300 is operated to displace the drive member 112 longitudinally, displacing the attached plunger disc 114 toward the front support member 136 within the cartridge receiving space 138. Thus, when a cartridge containing the work material is disposed in the cartridge receiving space defined between the cartridge frame members 134, the advancement of the drive member 112 toward the front support member 136 displaces the plunger disc 114 therewith, and a piston disc within the cartridge (not shown) correspondingly displaces the work material through a nozzle of the cartridge that has been opened for dispensing of the work material.

For any of dispensing guns 100a, 100b, 100c and 100d, the drive mechanism thereof may be of any suitable type known in the art. As such, the type of coupling between the drive mechanism and the drive member 112 may employ any suitable type of coupling mechanism. For example, a ratcheting type mechanism may operate on the drive member 112 that passes displaceably through the handle housing 120. The drive mechanism in the embodiment shown is configured to operate responsive to the back and forth displacement of the trigger 142 relative to the handle member 140. The trigger member 142 is pivotally coupled an upper portion of the handle member 140 or, alternately, in some dispensing gun configurations, to another portion of the handle housing 120, by such methods well known in the art. Typically, the trigger member 142 is biased by a spring or other resilient member (not shown), either directly or indirectly, to be displaced outward from the handle member 140 subsequent to having been squeezed toward the handle 140 in a pull stroke.

The trigger 142 is returned to its initial position by the spring, for displacement in a subsequent pull stroke. With each pull stroke, the drive mechanism incrementally advances the drive member 112, and the plunger disc 114 therewith, further into the cartridge receiving space, and then holds the drive member 112 in that position until the next stroke. The plunger disc 114 is positioned against the piston disc of the work material cartridge loaded there. As the drive mechanisms of dispensing guns are well known in the art, they are not described in any further detail.

As shown, the handle 140 and trigger 142 of dispensing gun 100a each have a substantially U-shaped cross-sectional contour, with the open ends of the U-shaped structures facing each other, and each defining a respective open space 1401, 1421 therein. Within the open spaces 1401 and 1421 there may be one or more ribs 1422 disposed therein to stiffen the respective structures. Where the handle 140 and/or trigger 142 is formed of a molded material or one that is diecast, the one or more ribs 1422 may be integrally formed therewith, In the particular configuration dispensing gun 100a shown, the open space 1421 of the trigger 142 defines a stowage space and includes a cartridge closure stowage cradle system 400 into which the cartridge closure plug 12 is releasably retained.

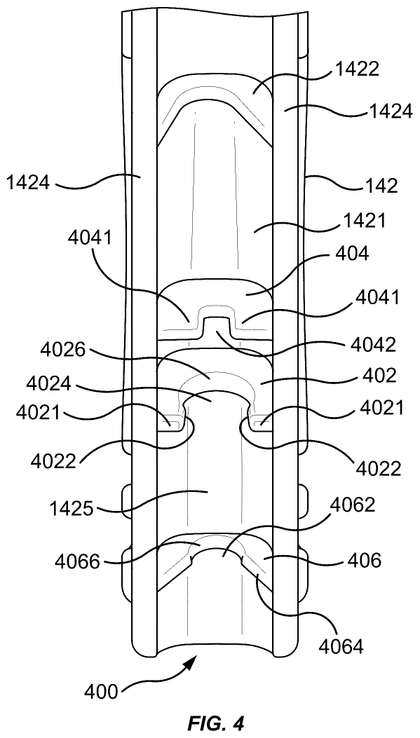

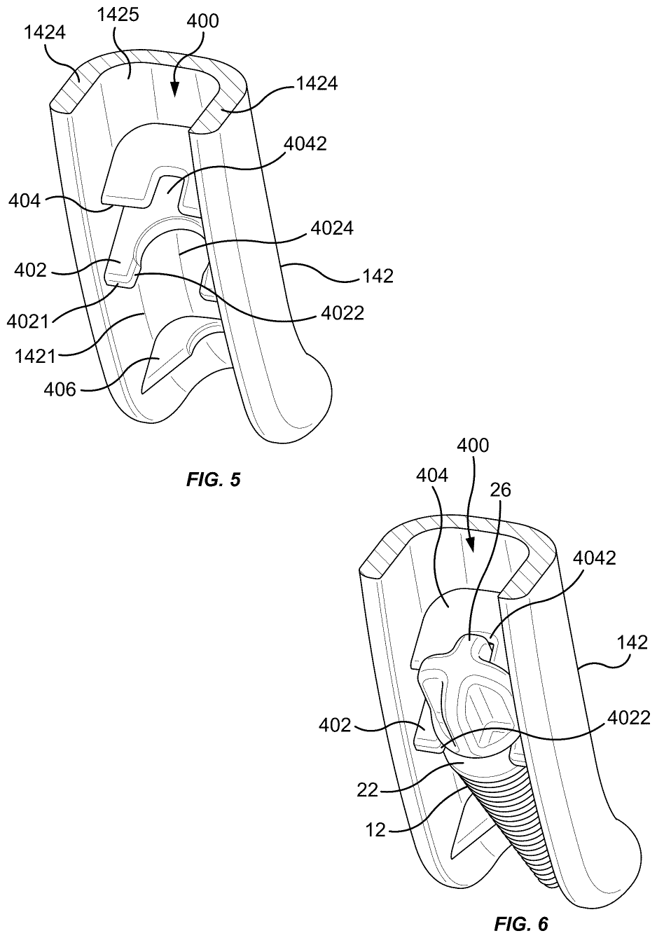

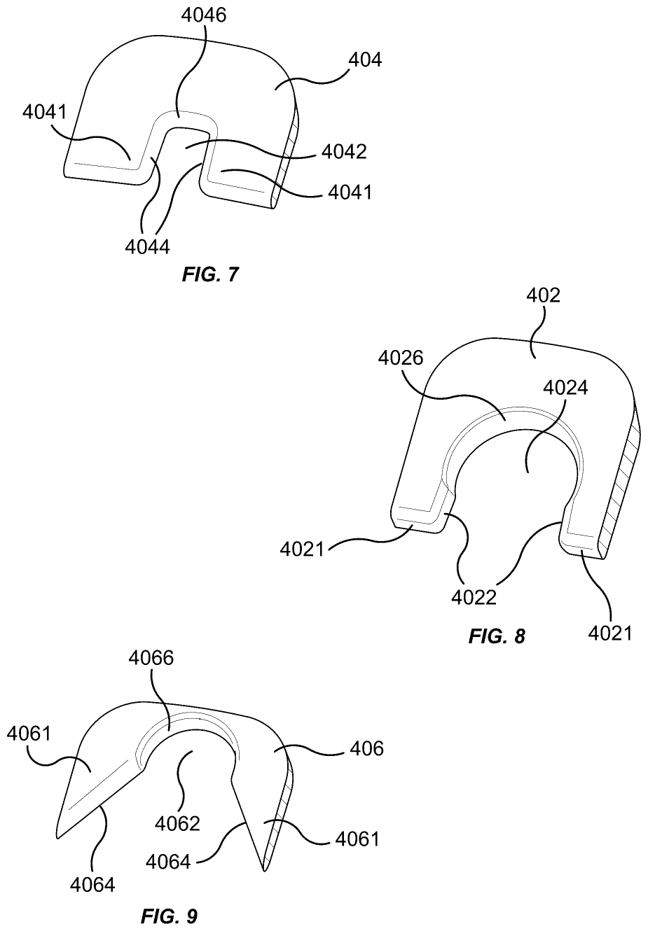

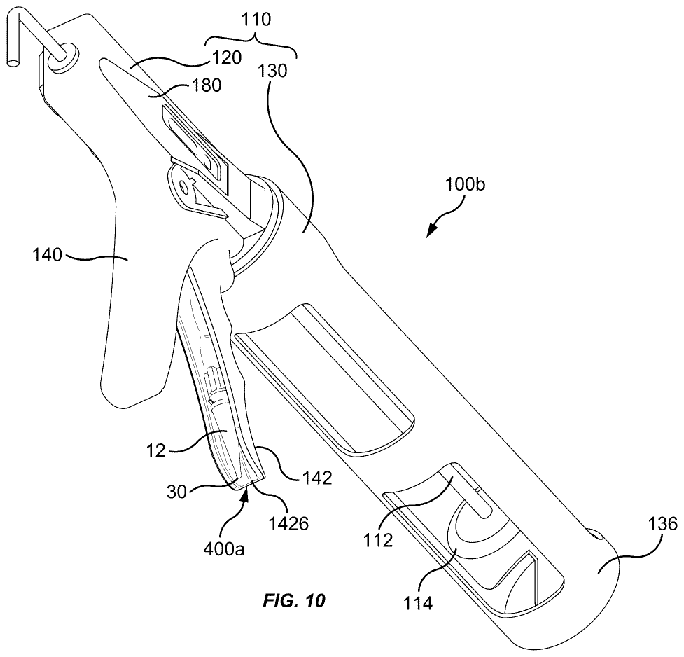

With reference to FIGS. 4-9, the cartridge closure stowage cradle system 400 of dispensing gun 100a can be seen in detail. The configuration of cartridge closure stowage cradle system 400 illustrated includes an engagement member 402 spanning between opposing side walls 1424 of the trigger 142 and extending to the bottom 1425 of the open space 1421. Engagement member 402 has a pair of laterally spaced arms 4021 extending longitudinally from an arcuate wall 4026, which together define a substantially U-shaped cartridge closure receiving opening 4024, and into which the circumferential groove 22 of the work material cartridge closure plug 12 is received. Proximal end portions of each of the arms 4021 have a projecting portion 4022 extending into the opening 4024 to thereby reduce an opening dimension of the cartridge closure receiving opening 4024 therebetween. The circumferential groove 22 portion of cartridge closure plug 12 is the portion the cartridge plug 12 that is positioned to correspond to the cartridge closure receiving opening 4024 and inserted therein. The opening dimension of the cartridge closure receiving opening 4024 established by the lateral distance between the pair of projecting portions 4022, 4022 is sufficiently less than a diameter of the circumferential groove 22 portion of cartridge closure plug 12 to provide an interference fit therebetween. By that arrangement, a “snap” type fit is provided as the circumferential groove 22 portion of the cartridge closure plug 12 is forced to pass between the projecting portions 4022, 4022. The projecting portions 4022, 4022 provide releasable frictional retention of the cartridge closure plug 12 within the retention opening 4024 of the engagement member 402. The lubricity of the material from which the cartridge closure plug 12 is formed and the fact that there is some lateral flexibility in the pair of side walls 1424 of the trigger 142, allow the cartridge closure plug 12 to be forced to pass through the interference fit of the narrowed opening dimension of the cartridge closure receiving opening 4024.

The cartridge closure stowage cradle system 400 further includes a cartridge closure supporting member 404 that aligns and supports the cartridge closure plug 12 within the stowage space 1421. The supporting member 404 is disposed in spaced relationship with the engagement member 402. Supporting member 404, like engagement member 402, spans between opposing side walls 1424 of the trigger 142 and extends to the bottom 1425 of the stowage space 1421. The supporting member 404 has a pair of laterally spaced arms 4041, 4041 that extend from a bottom wall 4046. The supporting member 404 further has a receiving opening 4042 formed between the opposing sidewalls 4044, 4044 of the arms 4041, 4041 and the bottom wall 4046. The opening 4042 is dimensioned to freely receive a wing 26 of the cartridge closure plug 12 therein when the cartridge closure plug 12 is being inserted into the cartridge closure stowage cradle system 400. In addition to aligning the longitudinal axis 15 of the cartridge closure plug 12 within the stowage space 1421, the supporting member 404 supports the cartridge closure plug 12 against rotative displacement, which displacement might cause disengagement of the cartridge closure plug 12 from retention by the engagement member 402.

The cartridge closure stowage cradle system 400 may also include a second supporting member 406 for supporting the lower portion 16 of the cartridge closure plug 12. Hereto, the supporting member 406 spans between opposing side walls 1424 of the trigger 142, extends to the bottom 1425 of the stowage space 1421, and is disposed in spaced relationship with the engagement member 402 on a side thereof opposite to that from which the supporting member 404 is spaced. Supporting member 406 has a receiving space 4062, in which the lower portion 16 of the cartridge closure plug 12 is received, that is formed between a pair of laterally spaced arms 4061,4061 and a U-shaped wall 4066. The entrance portion of the opening is defined by an inclined portion 4064 of each of the laterally spaced arms 4061, 4061 that respectively join a corresponding side of the U-shaped wall 4066. As illustrated in FIG. 2, the cartridge closure stowage cradle system 400 is located sufficiently close to the outer end 1426 of the trigger 142 to enable the user to easily use a their finger to contact and displace the terminal end 30 of the cartridge closure plug 12 and then disengage the circumferential groove 22 from the retention opening 4024 of the engagement member 402.

Any of the engagement member 402, supporting member 404 and the supporting member 406 may each be integrally formed in the trigger open space 1421, in one-piece formation, where the trigger 142 is formed of a material suitable for being molded, diecast, or otherwise manufactured in one piece. Alternately, any one or more of the engagement member 402, supporting member 404 and the supporting member 406 may be coupled to the trigger 142 within the open space 1421 by any of a variety of bonding techniques, such as adhesive bonding, ultrasonic welding, and soldering, as examples, or other known coupling methods.

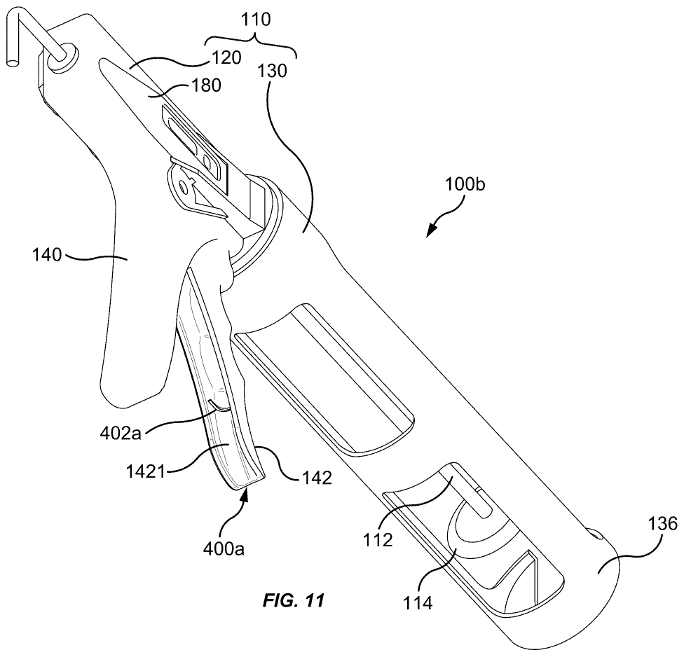

Referring now to FIGS. 10 and 11, there is shown a dispensing gun 100b having a cartridge closure stowage cradle system 400a. Dispensing gun 100b similarly includes a frame body 110 formed by a handle housing 120 and a cartridge frame 130 coupled to the handle housing 120 and extending longitudinally therefrom. The handle housing 120 includes a handle member 140 extending in a transverse direction with respect to the longitudinal direction of the cartridge frame 130, as is conventional. The handle housing 120 also includes a trigger member 142 that is pivotally connected to the handle member 140 and operatively coupled to a drive mechanism of the dispensing gun 100b, which is a conventional arrangement as well. Dispensing of the work material from a cartridge disposed in a cartridge receiving space, defined within the cartridge frame 130, is achieved by displacement of the drive member 112, and plunger disc 114 therewith, longitudinally toward the front support member 136 within the cartridge receiving space. The advancement of the drive member 112, and the plunger disc 114 therewith, toward the front support member 136 is driven by the drive mechanism located in the handle housing 120. The drive member 112 passes displaceably through the handle housing 120 and the cartridge receiving space of the cartridge frame 130 responsive to displacement of the trigger member 142 toward the handle member 140 by a connection of the trigger member 142 to the drive mechanism, as is conventional and therefore not shown. As is known in the art, the trigger member 142 is biased by a spring or other resilient member (not shown), either directly or indirectly, to thereby be subsequently displaced outward from the handle member 140 following a pull stoke of the trigger 142 toward the handle 140.

The drive mechanism incrementally advances and then holds the drive member 112, and the plunger disc 114 therewith, stationary within the cartridge receiving space upon each pull stroke of the trigger 142 toward the handle 140. With a cartridge containing the work material disposed in the cartridge receiving space, the advancement of the drive member 112 toward the front support member 136 displaces a piston disc located within the cartridge (not shown) to displace the work material through an open nozzle of the work material containing cartridge.

Dispensing gun 100b is like that of dispensing gun 100a, previously described, but has a handle housing 120 with a greater longitudinal extent, providing sufficient space for the accessory finishing tool 180 to be oriented longitudinally thereon. Dispensing gun 100b also differs in that the cartridge frame 130 has a semicylindrical contour to form a cradle that serves to support a cartridge of work material disposed in the cartridge receiving space defined by the semicylindrical cradle.

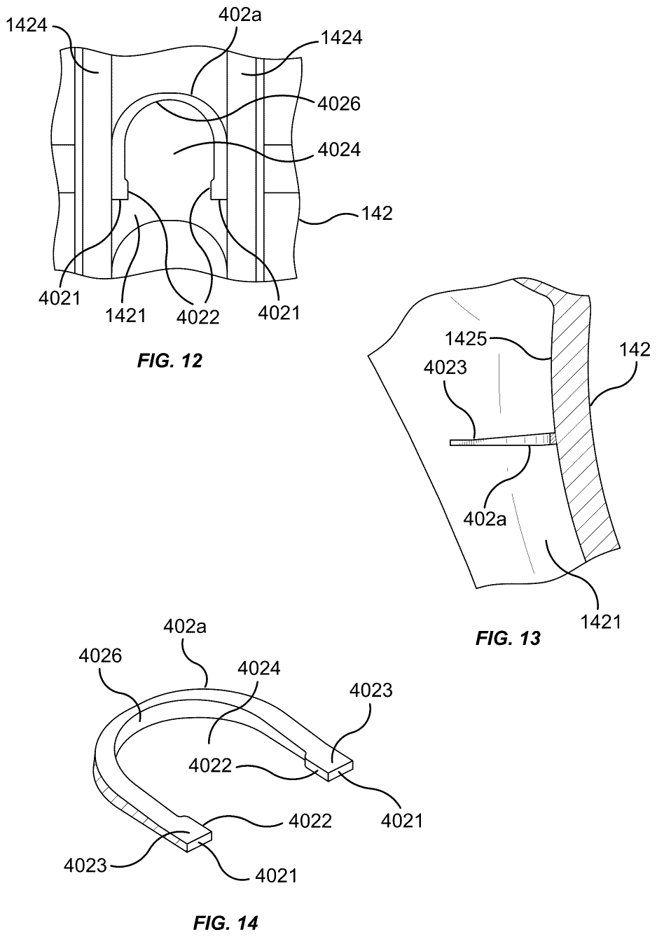

As shown, dispensing gun 100b includes a cartridge closure stowage cradle system 400a disposed within an open space 1421 of the trigger 142 for stowage of a cartridge closure plug 12. Cartridge closure stowage cradle system 400a includes an engagement member 402a disposed within the open space 1421. With additional reference to FIGS. 12-14, it can be seen that this configuration of cartridge closure stowage cradle system 400a includes an engagement member 402a that spans from one side wall 1424 to the opposing side wall 1424 of the trigger 142 and extending to the bottom 1425 of the open space 1421.

Engagement member 402a has a pair of laterally spaced arms 4021 extending longitudinally from an arcuate wall 4026 thereof which together define a substantially U-shaped cartridge closure receiving opening 4024 into which the circumferential groove 22 of the work material cartridge closure plug 12 is received. Proximal end portions of each of the arms 4021 have a projecting portion 4022 extending into the opening 4024 to thereby reduce an opening dimension therebetween. The opening dimension established by the lateral distance between the pair of projecting portions 4022, 4022 is sufficiently less than a diameter of the portion of the cartridge closure plug 12 corresponding to the circumferential groove 22, to provide an interference fit therebetween. By that arrangement, a “snap” type fit is provided as the circumferential groove 22 portion of the cartridge closure plug 12 is forced to pass between the projecting portions 4022, 4022. The projecting portions 4022, 4022 provide releasable frictional retention of the cartridge closure plug 12 within the retention opening 4024 of the engagement member 402a. Each of the arms 4021 have an inclined upper surface 4023 that tapers from the distal end at the arcuate wall 4026 to the proximal end thereof that makes engagement with the circumferential groove 22 of the cartridge closure plug 12 easier than it otherwise would be. The lubricity of the material from which the cartridge closure plug 12 is formed and the fact that there is some lateral flexibility in the pair of side walls 1424 of the trigger 142, allow the cartridge closure plug 12 to be forced to pass through the interference fit of the narrowed opening dimension of the cartridge closure receiving opening 4024. Referring back to FIG. 10, it can be seen that the cartridge closure stowage cradle system 400a is located sufficiently close to the outer end 1426 of the trigger 142 to enable the user to easily use a their finger to contact and displace the terminal end 30 of the cartridge closure plug 12 and then disengage the circumferential groove 22 from the retention opening 4024 of the engagement member 402a.

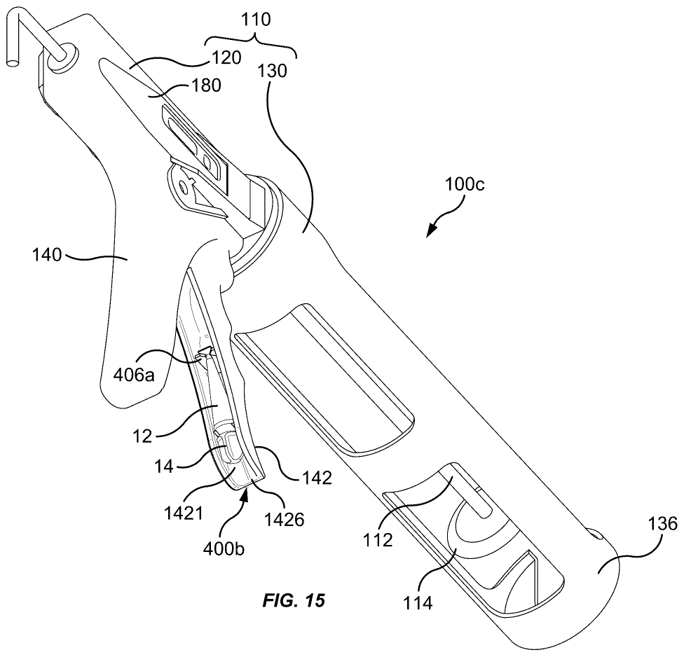

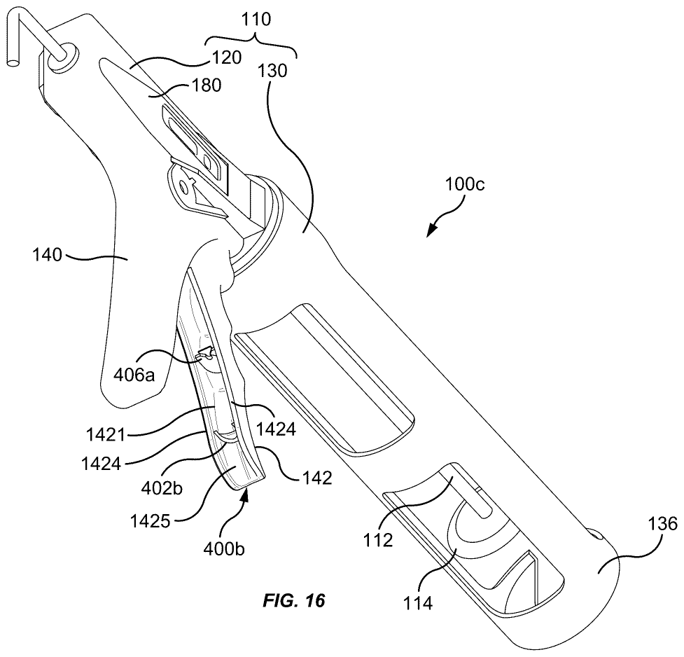

Cartridge closure stowage cradle system 400b is another configuration of the stowage cradle system and is shown incorporated in a dispensing gun 100c shown in FIGS. 15 and 16. Although not important to the inventive concepts disclosed herein, the cartridge closure stowage cradle system 400b illustrates the cartridge closure plug 12 being stowed within the open space 1421 of the trigger 142 with the terminal end 30 thereof facing upward, toward the pivotal connection of the trigger 142. The cartridge closure stowage cradle system 400b includes an engagement member 402b and a support member 406a longitudinally spaced from the engagement member 402b.

Dispensing gun 100c, similarly to those dispensing guns already discussed, includes a frame body 110 formed by a handle housing 120 and a cartridge frame 130 coupled to the handle housing 120 and extending longitudinally therefrom. The handle housing 120 includes a handle member 140 extending in a transverse direction with respect to the longitudinal direction of the cartridge frame 130, as is conventional. The handle housing 120 also includes a trigger member 142 that is pivotally connected to the handle member 140 and operatively coupled to a drive mechanism of the dispensing gun 100c, as is also conventional and therefore not shown. The drive mechanism includes a drive member 112 that is displaced longitudinally into a cartridge receiving space of the cartridge frame 130, which accordingly displaces the plunger disc 114, coupled to the drive member 112, toward the front support member 136 within the cartridge receiving space. The advancement of the drive member 112, and the plunger disc 114 therewith, toward the front support member 136 is responsive to displacement of the trigger member 142 toward the handle member 140 by a connection of the trigger member 142 to the drive mechanism, as is conventional. The trigger member 142 is biased by a spring or other resilient member (not shown), either directly or indirectly, to subsequently be displaced outward from the handle member 140 following a pull stoke of the trigger 142 toward the handle 140, which arrangement is conventional and therefore not shown.

Here again, the conventional drive mechanism incrementally advances and then holds the drive member 112, and the plunger disc 114 stationary within the cartridge receiving space defined in the semi cylindrically shaped cartridge frame 130 that supports a cartridge of work material therein. Through each pull stroke of the trigger 142 toward the handle 140, the drive member 112 is advanced. With a cartridge containing the work material being disposed in the cartridge receiving space, the advancement of the drive member 112 toward the front support member 136 displaces a piston disc located within the work material cartridge (not shown) to displace the work material through an open nozzle of the work material containing cartridge.

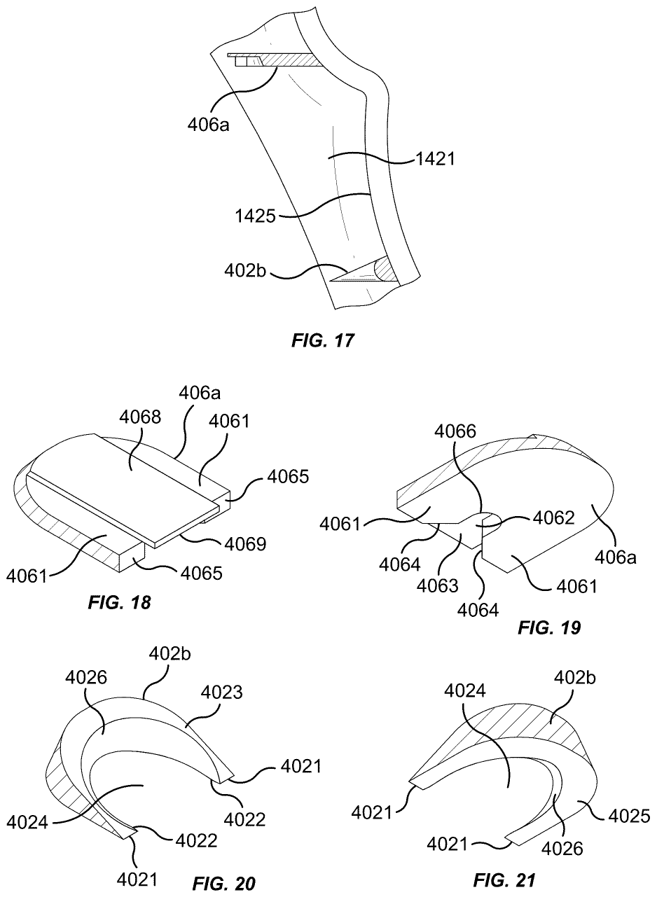

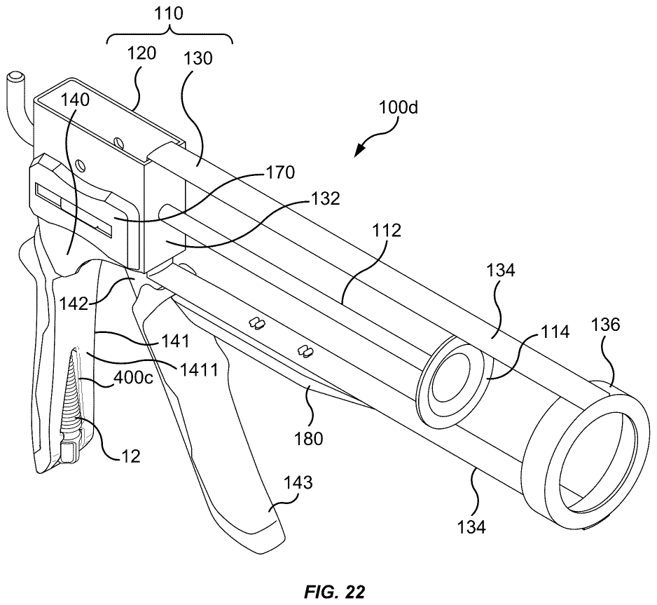

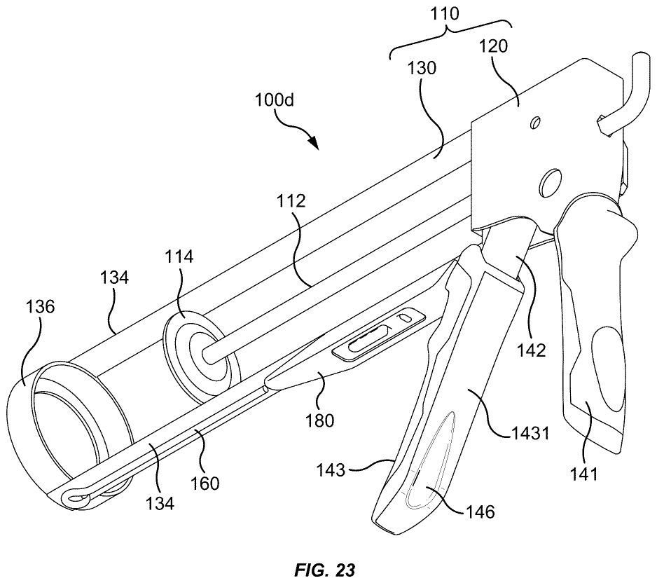

The configuration of cartridge closure stowage cradle system 400b can best be discerned with additional reference to FIGS. 17-21. The engagement member 402b spans between opposing side walls 1424 of the trigger 142 and extends to the bottom 1425 of the open space 1421. Engagement member 402b has a pair of laterally spaced arms 4021 extending longitudinally from an arcuate wall 4026 which together define a substantially U-shaped cartridge closure receiving opening 4024 extending from the arcuate wall 4026 to the opening between the two arms 4021 and into which the circumferential groove 22 of the work material cartridge closure plug 12 is received. Proximal end portions of each of the arms 4021 have a projecting portion 4022 extending into the opening 4024 to thereby reduce an opening dimension therebetween. The opening dimension established by the lateral distance between the pair of projecting portions 4022, 4022 is sufficiently less than a diameter of the portion of the cartridge closure plug 12 corresponding to the circumferential groove 22, to provide an interference fit therebetween. By that arrangement, a “snap” type fit is provided as the circumferential groove 22 portion of the cartridge closure plug 12 is forced to pass between the projecting portions 4022, 4022. The projecting portions 4022, 4022 provide releasable frictional retention of the cartridge closure plug 12 within the retention opening 4024 of the engagement member 402b. The engagement member 402b has a planar lower wall 4025 and an inclined upper wall 4023 providing a reduced height at the proximal ends of arms 4021, 4021, and thereby making it easier to engage and disengage the cartridge closure plug 12 from between the projecting portions 4022, 4022. The lubricity of the material from which the cartridge closure plug 12 is formed and the fact that there is some lateral flexibility in the pair of side walls 1424 of the trigger 142, allow the cartridge closure plug 12 to be forced to pass through the interference fit of the narrowed opening dimension of the cartridge closure receiving opening 4024.

The support member 406a spans between the pair of opposing side walls 1424 of the trigger 142, extends to the bottom 1425 of the stowage space 1421, and is disposed in spaced relationship with the engagement member 402a on a side thereof facing the trigger side of the trigger. Support member 406a has an opening 4062 adapted to receive the lower portion of 16 of the cartridge closure plug 12 therein. The opening 4062 is formed between a pair of laterally spaced arms 4061,4061 and a U-shaped wall 4066. An entrance portion of the opening is defined between inclined wall portions 4064, 1064 of the corresponding laterally spaced arms 4061, 4061. The pair of inclined wall portions 4064, 4064 are oppositely inclined to thereby increase an opening dimension of the opening 4262 defined therebetween

Support member 406a further includes a backstop member 4068 that is disposed on a side of support member 406a facing toward the pivoted end of the trigger 142 and coupled thereto. The backstop member 4068 extends from the bottom 1425 of the stowage space 1421 and outwardly therefrom to overlay the opening 4062 on one side of the support member 406a, presenting an exposed surface 4063 through the opening. The backstop member 4068 has an outermost end 4069 that extends beyond the outermost end 4065 of each of the arms 4061, 4061. By this arrangement, The cartridge closure plug 12 is installed in the cartridge closure stowage cradle system 400b by inserting the terminal end portion 30 into the trigger open space 1421 and contacting the backstop member 4068 to properly longitudinally position the cartridge closure plug 12. Then, the head portion 14 of the cartridge closure plug 12 is pivoted about the terminal end into the open space to engage the circumferential groove 22 in the retention opening 4024 of engagement member 402b. Thus, it can be understood that the backstop member 4068 is spaced from engagement member 402b to position the circumferential groove 22 of the cartridge closure plug 12 in correspondence with the retention opening 4024 of the engagement member 402b Therefore, by contacting the backstop member 4068 with the terminal end 30 of cartridge closure plug 12, the circumferential groove 22 thereof will be aligned with the retention opening 4024. As seen in FIG. 15, the cartridge closure stowage cradle system 400b is located sufficiently close to the outer end 1426 of the trigger 142 so that the user can easily use a their finger to contact and displace the head end 14 of the cartridge closure plug 12 to disengage the circumferential groove 22 from the retention opening 4024 of the engagement member 402b. The ability to remove the cartridge closure plug 12 is further facilitated by the dimension between the bottom wall 4026 of the retention opening 4024 of the engagement member 402b and the bottom 1425 of the stowage space 1421 being chosen to provide a sufficient gap to allow a user a finger to lift the head portion 14 of the cartridge closure plug 12 and rotate the cartridge closure plug 12 about the terminal end 30 thereof disposed against the exposed backstop surface 4063 to thereby displace the circumferential groove 22 from the cartridge closure retention opening 4024.

Another cartridge closure stowage cradle system configuration is illustrated in FIGS. 22-25, wherein a dispensing gun 100d includes cartridge closure stowage system 400c. Dispensing gun 100d has a frame body 110 that includes a handle hosing 120 and a cartridge frame 130 extending longitudinally from the handle housing 120. Handle housing 120 encloses a drive mechanism (not shown), as is conventional in such dispensing guns. The handle housing 120 further includes a handle member 140 which may in turn include a grip 141 sleeved thereon, and a trigger member 142 pivotally coupled to the handle housing, which likewise may include a grip 143 sleeved thereon. As is conventional, the drive mechanism is actuated to displace a drive member 112 that extends longitudinally through the handle housing 120 into a cartridge receiving space within the cartridge frame 130 toward the front support member 136 responsive to the operation of the trigger member 142 in the manner previously described.

The cartridge frame 130 includes rear support member 132 affixed to the handle housing 120 and a pair of frame members 134, 134 extending longitudinally to the front support member 136. Although not important to the inventive concepts disclosed herein, front support member 136 has an annular contour into which the nozzle portion of a work material cartridge is received. The front support member 136 may be formed with an open portion that functions as a passageway for the nozzle portion of the work material cartage to pass therethrough during insertion and removal of the cartridge into and out from the cartridge receiving space of the cartridge frame 130 that is bounded by the front and rear support members 132 and 136, and the pair of diametrically opposed cartridge frame members 134, 134. The frame body 110 also includes systems for accessory tool stowage, wherein an accessory finishing tool 170 is releasably engaged to the handle housing 120, and an accessory scrapper tool 180 is releasably engaged to one of the cartridge frame members 134, the selection of which is arbitrary.

The cartridge closure stowage system 400c of dispensing gun 100d is disposed in the inner surface 1411 of the handle grip 141, which surface faces the trigger 142. As was discussed with respect to the dispensing guns 100a, 100b and 100c, the handle 140 has a U-shaped cross-sectional structure with the open side thereof facing the trigger, and the trigger 142 has a U-shaped cross-sectional structure with the open side thereof facing the handle 140. Although not shown, it should be understood from the discussion of dispensing guns 100a, 100b and 100c that the surface 1411 of the handle grip 141 overlays the open space of the handle 140, and the surface 1431 of the trigger grip 143 overlays the open space of the trigger 142. That arrangement permits a recess 144 to be molded into the surface 1411 of handle grip 141 and the cartridge closure stowage system 400c incorporated into the molded recess.

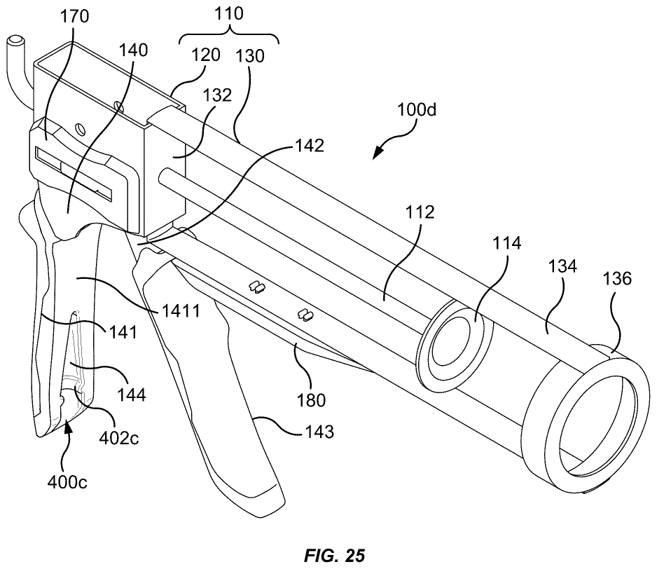

In the normal operation of dispensing gun 100d, the trigger is often drawn to the handle to the extent that the handle facing side 1431 of the trigger grip 143 contacts the trigger facing side 1411 of the handle grip 141. However, as illustrated in FIG. 22, a portion of the cartridge closure plug 12 extends out from the stowage space 144 (shown in FIGS. 24 and 25. Thus, in order to allow the trigger to be cycled through a full stroke, a recess 146 is formed in the handle facing surface 1431 of the trigger grip 143, overlaying the open side of the trigger 142, which open side was described with respect to the dispensing guns 100a, 100b and 100c. Recess 146 provides a space into which an outward projecting portion of the cartridge closure plug 12 is received when the trigger 142 is displaced to its fullest extent toward the handle 140. Recess 146 has a contour configured with a shape to accommodate the projecting portion of the cartridge closure plug 12 and provides clearance for contactless receipt of the projecting portion within the recess 146.

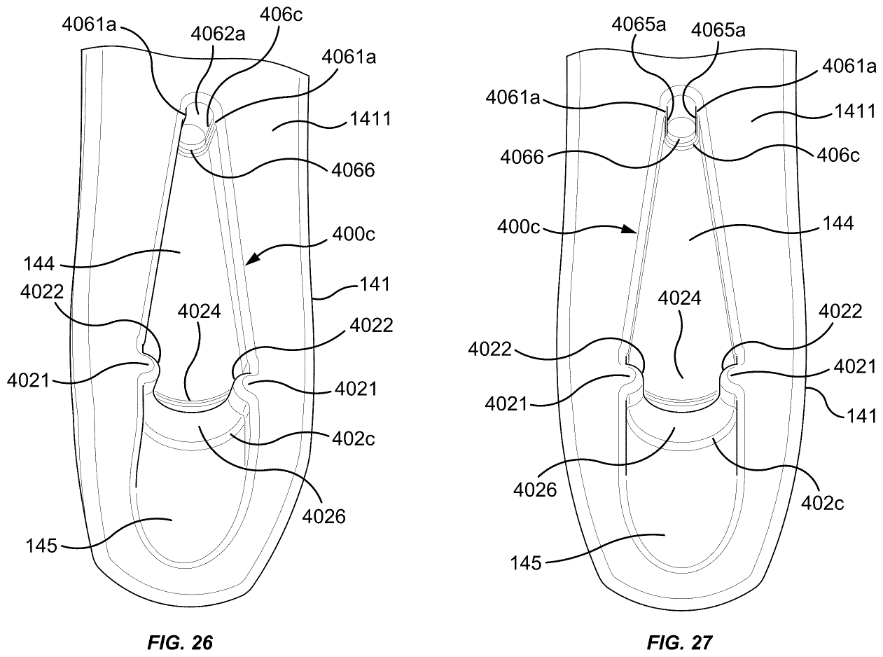

The stowage space 144 of cartridge closure stowage system 400c has a contour that substantially mirrors a contour of the cartridge closure plug 12 and includes an engagement member 402c integrally formed in the molded side 1411 of the handle grip 141 positioned to correspond to the circumferential groove of the cartridge closure plug 12. Referring additionally to FIGS. 26 and 27, it can be seen that engagement member 402c has an arcuate wall 4026 disposed in the recess 144 and from which a pair of laterally spaced arms 4021 extend longitudinally to be flush with the surface 1411, and together define a substantially U-shaped cartridge closure receiving opening 4024 into which the circumferential groove 22 of the work material cartridge closure plug 12 is received. Proximal end portions of each of the arms 4021 have a projecting portion 4022 extending into the opening 4024 to thereby reduce an opening dimension therebetween. The opening dimension established by the lateral distance between the pair of projecting portions 4022, 4022 is sufficiently less than a diameter of the portion of the cartridge closure plug 12 corresponding to the circumferential groove 22, to provide an interference fit therebetween. By that arrangement, a “snap” type fit is provided as the circumferential groove 22 portion of the cartridge closure plug 12 is forced to pass between the projecting portions 4022, 4022. The projecting portions 4022, 4022 provide releasable frictional retention of the cartridge closure plug 12 within the retention opening 4024 of the engagement member 402c. The lubricity of the material from which the cartridge closure plug 12 and the material of the handle grip 141 are each formed and the fact that there is some lateral flexibility of the material of the handle grip 141, allow the cartridge closure plug 12 to be forced to pass through the interference fit of the narrowed opening dimension of the cartridge closure receiving opening 4024.

Cartridge closure stowage system 400c further includes a second engagement member 406c into which the lower portion 16 adjacent the terminal end 30 of the cartridge closure plug 12 is releasable retained. The second engagement member 406c has a U-shaped wall 4066 from which a pair of laterally spaced arms 4061a extend longitudinally to be flush with the surface 1411, and which together define a substantially U-shaped a receiving opening 4062a into which the lower portion 16 adjacent the terminal end 30 of the work material cartridge closure plug 12 is received. Proximal end portions of each of the arms 4061a have a projecting portion 4065a extending into the opening 4062a to thereby reduce an opening dimension therebetween. The opening dimension established by the lateral distance between the pair of projecting portions 4062a, 4062a is sufficiently less than a diameter of the corresponding lower portion 16 adjacent the terminal end 30 of the cartridge closure plug 12, to provide an interference fit therebetween. The second engagement member 406c thereby provides the same “snap” type fit of releasable engagement with the terminal end portion of the cartridge closure plug 12 as that provided by the engagement member 402c with respect to the circumferential groove 22 of cartridge closure plug 12.

When a cartridge closure plug 12 is engaged within the stowage space 144, the head portion 14 of the cartridge closure plug 12 is disposed in correspondence with the molded end portion 145 of the stowage space 144. The molded end portion 145 of the stowage space 144 is inclined inwardly so as to create a gap between the surface of the molded end portion 145 and the facing surface of the head portion 14 of the cartridge closure plug 12, and thereby provide sufficient space for a user's finger to easily dislodge the cartridge closure plug 12 from the stowage space 144.

The descriptions above are intended to illustrate possible implementations of the present invention and are not restrictive. While this invention has been described in connection with specific forms and embodiments thereof, it will be appreciated that various modifications other than those discussed above may be resorted to without departing from the spirit or scope of the invention. Such variations, modifications, and alternatives will become apparent to the skilled artisan upon review of the disclosure. For example, functionally equivalent elements may be substituted for those specifically shown and described, and certain features may be used independently of other features, and in certain cases, particular locations of elements may be reversed or interposed, all without departing from the spirit or scope of the invention as defined in the appended Claims. The scope of the invention should therefore be determined with reference to the description above, the appended claims and drawings, along with their full range of equivalents.

What is claimed is:

1. A stowage cradle system incorporated into a dispensing gun for stowage of a work material cartridge closure, the dispensing gun having a frame body configured for extruding a work material from a cartridge, a handle extending from the frame body and a trigger being angularly displaceable with respect to said handle, said cradle system comprising at least one engagement member disposed in an interior space of one of the handle or the trigger to define a stowage space for the work material cartridge closure, said engagement member having a pair of laterally spaced arms extending longitudinally from an arcuate wall disposed therebetween, said engagement member having a retention opening defined between said pair of arms and said arcuate wall, end portions of each of said arms having a projecting portion extending into said retention opening to reduce an opening dimension therebetween, wherein the work material cartridge closure is releasably frictionally retained within said retention opening by said projecting portions of said pair of arms of said engagement member.

2. The stowage cradle system as recited in claim 1, wherein said stowage space is formed in the handle of the dispensing gun.

3. The stowage cradle system as recited in claim 2, wherein said stowage space is formed as a longitudinally extended recess formed in a handle grip overlaying the handle of the dispensing gun.

4. The stowage cradle system as recited in claim 3, wherein the trigger has an overlaying trigger grip, the trigger grip having a rear side facing said longitudinally extended recess of the handle grip, the rear side of the trigger grip having a recess formed therein and located in correspondence with said stowage space to provide clearance between the work material cartridge closure retained within said stowage space and the rear side of the trigger grip.

5. The stowage cradle system as recited in claim 3, wherein said longitudinally extended recess has a contour substantially mirroring a contour of the work material cartridge closure, said engagement member being integrally formed in an interior wall of said longitudinally extended recess.

6. The stowage cradle system as recited in claim 5, further comprising a second engagement member formed at one end of said longitudinally extended recess and into which a distal end of the work material cartridge closure is releasably frictionally retained thereby.

7. The stowage cradle system as recited in claim 6, wherein said second engagement member has a substantially U-shaped contour to define a retention opening into which the distal end of the work material cartridge closure is received, said second engagement member having a pair of projecting portions extending into said retention opening thereof to reduce an opening dimension between opposing sides of said retention opening of second engagement member to thereby releasably frictionally retain the distal end of the work material cartridge closure within said retention opening thereof.

8. The stowage cradle system as recited in claim 1, further comprising at least one supporting member disposed in said stowage space and longitudinally spaced from said engagement member, said at least one supporting member including a receiving opening formed therein and into which a portion of the work material cartridge closure is inserted when being retained by said engagement member.

9. The stowage cradle system as recited in claim 8, wherein said receiving opening is closed on one side of said supporting member to limit longitudinal positioning of the work material cartridge closure when being positioned in said stowage space.

10. The stowage cradle system as recited in claim 1, further comprising a first supporting member disposed in said stowage space and longitudinally spaced from one side of said engagement member, and a second supporting member disposed in said stowage space and longitudinally spaced from an opposing side of said engagement member, each of said first and second supporting members including respective receiving openings formed therein and into which a corresponding portion of the work material cartridge closure is inserted when being retained by said engagement member.

11. The stowage cradle system as recited in claim 10, wherein said receiving opening formed in said second supporting member being configured to engage the work material cartridge closure against rotation thereof.

12. A dispensing gun having work material cartridge closure onboard stowage system, comprising:
a frame body including a handle housing and a cartridge frame portion extending from said handle housing and adapted for receiving a cartridge of a work material therein;
a handle extending from said handle housing;
a drive mechanism operably coupled to said frame body, said drive mechanism including a drive member passing displaceably into the cartridge frame portion for forcing extrusion of work material from a cartridge of work material selectively positioned in said cartridge frame portion;
a trigger pivotally coupled to said frame body for angular displacement of said trigger relative to said handle, said trigger being operatively coupled to said drive mechanism for displacing said drive member responsive to the angular displacement of said trigger; and
a stowage cradle system disposed in an interior space of one of said handle or said trigger to define a stowage space into which a work material cartridge closure is releasably retained, said stowage cradle system including at least one engagement member configured to releasably frictionally retain the work material cartridge closure within a retention opening formed in said at least one engagement member.

13. The dispensing gun as recited in claim 12, wherein said stowage space is formed in said handle of said dispensing gun.

14. The dispensing gun as recited in claim 13, wherein said stowage space is formed as a longitudinally extended recess formed in a handle grip overlaying said handle of the dispensing gun.

15. The dispensing gun as recited in claim 14, wherein said trigger has an overlaying trigger grip, said trigger grip having a rear side facing said longitudinally extended recess of said handle grip, said rear side of the trigger grip having a recess formed therein and located in correspondence with said stowage space to provide clearance between the work material cartridge closure retained within said stowage space and said rear side of the trigger grip.

16. The dispensing gun as recited in claim 14, wherein said longitudinally extended recess has a contour substantially mirroring a contour of the work material cartridge closure, said engagement member being integrally formed in an interior wall of said longitudinally extended recess.

17. The dispensing gun as recited in claim 16, wherein said stowage cradle system further includes a second engagement member formed at one end of said longitudinally extended recess and into which a distal end of the work material cartridge closure is releasably frictionally retained thereby.

18. The dispensing gun as recited in claim 17, wherein said second engagement member has a substantially U-shaped contour to define a retention opening formed therein and into which the distal end of the work material cartridge closure is received, said second engagement member having a pair of projecting portions extending into said retention opening thereof to reduce an opening dimension between opposing sides of said retention opening of said second engagement member to thereby releasably frictionally retain the distal end of the work material cartridge closure within said retention opening thereof.

19. The dispensing gun as recited in claim 12, wherein said stowage cradle system further includes at least one supporting member disposed in said stowage space and longitudinally spaced from said engagement member, said at least one supporting member including a receiving opening formed therein and into which a portion of the work material cartridge closure is inserted when being retained by said engagement member.

20. The dispensing gun as recited in claim 19, wherein said receiving opening is closed on one side of said supporting member to limit longitudinal positioning of the work material cartridge closure when being positioned in said stowage space.

21. The dispensing gun as recited in claim 12, further comprising a first supporting member disposed in said stowage space and longitudinally spaced from one side of said engagement member, and a second supporting member disposed in said stowage space and longitudinally spaced from an opposing side of said engagement member, each of said first and second supporting members including respective receiving openings formed therein and into which a corresponding portion of the work material cartridge closure is inserted when being retained by said engagement member.

22. The dispensing gun as recited in claim 21, wherein said receiving opening formed in said second supporting member being configured to engage the work material cartridge closure against rotation thereof.
